(19) United States
(12) Patent Application Publication
(10) Pub. No.: US 2022/0148423 A1
(43) Pub. Date: May 12, 2022

(54) VEHICLE NOTIFICATION APPARATUS AND VEHICLE NOTIFICATION SYSTEM

(71) Applicant: Honda Motor Co., Ltd., Tokyo (JP)

(72) Inventor: Masahiko Asakura, Tokyo (JP)

(21) Appl. No.: 17/521,329

(22) Filed: Nov. 8, 2021

(30) Foreign Application Priority Data
Nov. 12, 2020 (JP) 2020-188743

(51) Int. Cl. G08G 1/0967; G08G 1/16

(52) U.S. Cl. CPC G08G 1/096708; G08G 1/096791; G08G 1/166

(57) ABSTRACT

A vehicle notification apparatus includes: a positioning sensor detecting a position of the vehicle and a microprocessor. The microprocessor performs: acquiring a position data of an emergency vehicle; notifying an approach information of the emergency vehicle; and determining whether the emergency vehicle is approaching the vehicle based on the position of the vehicle detected by the positioning sensor and the acquired position data. The microprocessor performs further determining whether a notification of the approach information is permitted based on a command transmitted from the emergency vehicle, and when it is determined that the emergency vehicle is approaching the vehicle and that the notification of the approach information is permitted, notifying an occupant of the approach information, while when it is determined that the notification of the approach information is not permitted, not notifying the approach information.

### CROSS-REFERENCE TO RELATED APPLICATION

This application is based upon and claims the benefit of priority from Japanese Patent Application No. 2020-188743 filed on Nov. 12, 2020, the content of which is incorporated herein by reference.

### BACKGROUND OF THE INVENTION

### Field of the Invention

This invention relates to a vehicle notification apparatus and a vehicle notification system configured to notify an occupant of a vehicle of an approach of an emergency vehicle such as an ambulance and a police car.

### Description of the Related Art

As this type of apparatus, there has been conventionally known an apparatus configured to notify a vehicle present on a planned travel route of a traveling emergency vehicle of information indicating a current position and the planned travel route of the emergency vehicle. Such an apparatus is disclosed, for example, in Japanese Unexamined Patent Publication No. 2019-168998 (JP2019-168998A).

By the way, depending on the emergency vehicle, there is a case where it is not desired for occupants of the surrounding vehicles to know the position of the traveling emergency vehicle. However, in the apparatus described in JP 2019-168998 A, even in such a case, the position of the emergency vehicle may be notified and known to the occupants of the surrounding vehicles.

### SUMMARY OF THE INVENTION

An aspect of the present invention is a vehicle notification apparatus notifying an occupant of a vehicle of an approach of an emergency vehicle. The vehicle notification apparatus includes a positioning sensor detecting a position of the vehicle; and a microprocessor and a memory coupled to the microprocessor. The microprocessor is configured to perform acquiring a position data of the emergency vehicle, notifying an approach information of the emergency vehicle, and determining whether the emergency vehicle is approaching the vehicle based on the position of the vehicle detected by the positioning sensor and the position data acquired in the acquiring. The microprocessor is configured to perform the determining including further determining whether a notification of the approach information is permitted based on a command transmitted from the emergency vehicle and the notifying including, when it is determined that the emergency vehicle is approaching the vehicle and that the notification of the approach information is permitted, notifying the occupant of the approach information of the emergency vehicle, while when it is determined that the notification of the approach information is not permitted, not notifying the approach information even if it is determined that the emergency vehicle is approaching the vehicle.

### BRIEF DESCRIPTION OF THE DRAWINGS

The objects, features, and advantages of the present invention will become clearer from the following description of embodiments in relation to the attached drawings, in which:

FIG. 1 is a diagram showing a configuration overview of a driving system of a self-driving vehicle incorporating a vehicle control system according to an embodiment of the present invention;

FIG. 2 is a block diagram schematically illustrating an overall configuration of a vehicle control system according to an embodiment of the present invention;

FIG. 3 is a diagram illustrating an example of a vehicle avoidance system including the vehicle control system according to an embodiment of the present invention;

FIG. 4 is a block diagram illustrating a configuration of a substantial part of a vehicle notification apparatus according to an embodiment of the present invention;

FIG. 5 is a block diagram schematically illustrating an overall configuration of an in-vehicle apparatus of the emergency vehicle in FIG. 3;

FIG. 6 is a flowchart showing an example of processing executed by a CPU of the controller in FIG. 4;

FIGS. 7A to 7C are diagrams schematically illustrating a state in which an emergency vehicle is tracking an escaping vehicle;

FIG. 8 is a block diagram illustrating a configuration of main components of a vehicle control apparatus according to an embodiment of the present invention;

FIG. 9 is a flowchart illustrating an example of processing executed by a CPU of the controller in FIG. 8; and

FIGS. 10A to 10D are diagrams schematically illustrating a state in which an emergency vehicle is urgently traveling.

### DETAILED DESCRIPTION OF THE INVENTION

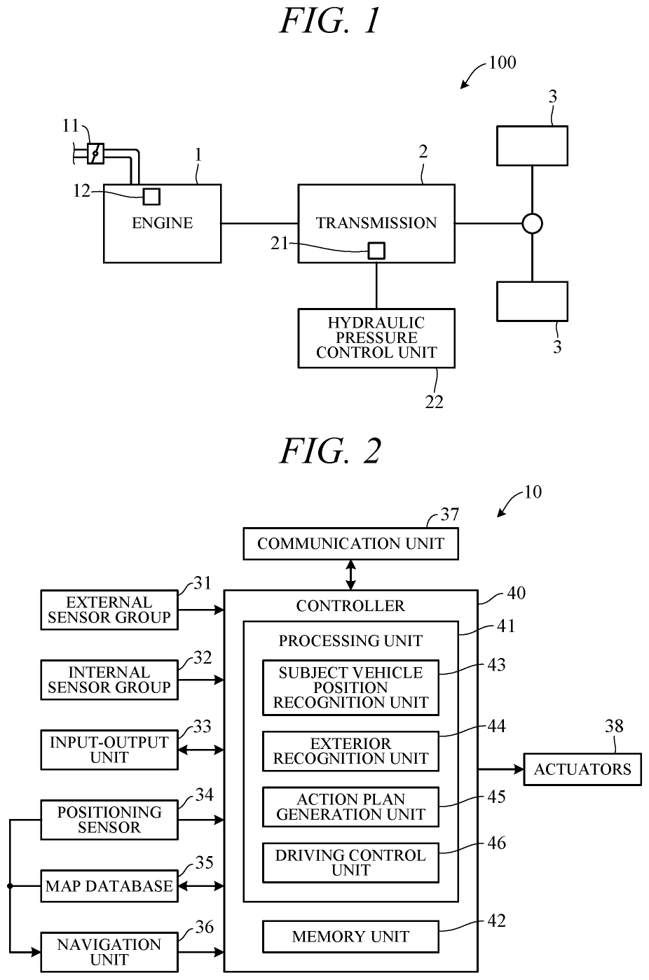

Hereinafter, an embodiment of the present invention is explained with reference to FIGS. 1 to 10D. A vehicle control system according to an embodiment of the present invention is applied to a vehicle (self-driving vehicle) having a self-driving capability. FIG. 1 is a diagram showing a configuration overview of a driving system of a self-driving vehicle 100 incorporating a vehicle control system according to the present embodiment. Herein, the self-driving vehicle may be sometimes called “subject vehicle” to differentiate it from other vehicles. The vehicle 100 is not limited to driving in a self-drive mode requiring no driver driving operations but is also capable of driving in a manual drive mode by driver operations. In the present embodiment, a driving mode that does not require all operations including the accelerator pedal operation, brake operation, and steering operation is referred to as a self-driving mode.

As illustrated in FIG. 1, a vehicle 100 includes an engine 1 and a transmission 2. The engine 1 is an internal combustion engine (for example, a gasoline engine) that mixes intake air supplied via a throttle valve 11 and fuel injected from an injector 12 at an appropriate ratio, and ignites the mixture by an ignition plug or the like to burn the mixture, and thus to generate rotational power. Various engines such as a diesel engine can be used instead of the gasoline engine. An intake air amount is adjusted by the throttle valve 11, and an opening degree of the throttle valve 11 is changed by driving of a throttle actuator operated by an electric signal. The opening degree of the throttle valve 11 and an amount of fuel injected from the injector 12 (injection period, injection time) are controlled by a controller 40 (FIG. 2).

The transmission 2 is provided on a power transmission path between the engine 1 and a drive wheel 3, varies speed ratio of rotation of the engine 1, and converts and outputs a torque from the engine 1. The rotation varied by the transmission 2 is transmitted to the drive wheel 3, thereby propelling the vehicle 100. The vehicle 100 can be configured as an electric vehicle or a hybrid vehicle by providing a traveling motor as a drive power source instead of or in addition to the engine 1.

The transmission 2 is, for example, a stepped transmission enabling stepwise speed ratio according to a plurality of shift stages. A continuously variable transmission enabling stepless speed ratio shifting can also be used as the transmission 2. Although not illustrated, power from the engine 1 may be input to the transmission 2 via a torque converter. The transmission 2 includes, for example, an engagement element 21 such as a dog clutch or a friction clutch, and a hydraulic pressure control unit 22 controls a flow of oil from a hydraulic source to the engagement element 21, so that the shift stage of the transmission 2 can be changed. The hydraulic pressure control unit 22 includes a control valve driven by an electric signal, and can set an appropriate shift stage by changing a flow of pressure oil to the engagement element 21 according to the drive of the control valve.

FIG. 2 is a block diagram schematically illustrating an overall configuration of a vehicle control system 10 according to the present embodiment. As illustrated in FIG. 2, the vehicle control system 10 mainly includes a controller 40, an external sensor group 31, an internal sensor group 32, an input-output unit 33, a positioning sensor 34, a map database 35, a navigation unit 36, a communication unit 37, and actuators 38 each electrically connected to the controller 40.

The external sensor group 31 is a generic term for a plurality of sensors that detect external circumstances which are peripheral information of the vehicle 100. For example, the external sensor group 31 includes a LIDAR (Light Detection and Ranging) that measures scattered light produced by laser light radiated from the subject vehicle in every direction and measures a distance from the vehicle 100 to surrounding obstacles, and a RADAR (Radio Detection and Ranging) that detects other vehicles, obstacles, and the like around the vehicle 100 by radiating electromagnetic waves and detecting reflected waves. Furthermore, for example, the external sensor group 31 includes a camera that is mounted on the vehicle 100, has an imaging element such as a CCD or a CMOS, and images a periphery (forward, reward and sideward) of the vehicle 100, a microphone that inputs a signal of sound from the periphery of the vehicle 100 (hereinafter, the microphone is simply referred to as a microphone), and the like. A signal detected by the external sensor group 31 and a signal input to the external sensor group 31 are transmitted to the controller 40.

The internal sensor group 32 is a collective designation encompassing a plurality of sensors that detect a traveling state of the vehicle 100 and a state inside the vehicle.

For example, the internal sensor group 32 includes a vehicle speed sensor that detects a vehicle speed of the vehicle 100, an acceleration sensor that detects an acceleration in a front-rear direction of the vehicle 100 and an acceleration in a left-right direction (lateral acceleration) of the vehicle 100, an engine speed sensor that detects rotational speed of the engine 1, a yaw rate sensor that detects rotation angle speed around a vertical axis through the vehicle 100, a throttle position sensor that detects the opening degree (throttle opening) of the throttle valve 11, and the like. The internal sensor group 32 further includes a sensor that detects driver's driving operation in a manual drive mode, for example, operation of an accelerator pedal, operation of a brake pedal, operation of a steering wheel, and the like. A detection signal from the internal sensor group 32 is transmitted to the controller 40.

The input-output unit 33 is a generic term for devices in which a command is input from a driver or information is output to the driver. For example, the input-output unit 33 includes various switches to which the driver inputs various commands by operating an operation member, a microphone to which the driver inputs a command by voice, a display that provides information to the driver via a display image, a speaker that provides information to the driver by voice, and the like. The various switches include a mode select switch that instructs either a self-drive mode or a manual drive mode.

The mode select switch is configured as, for example, a switch manually operable by a driver, and outputs a mode select command to the self-drive mode in which a self-driving capability is enabled or the manual drive mode in which the self-driving capability is disabled according to a switch operation. Switching from the manual drive mode to the self-drive mode or switching from the self-drive mode to the manual drive mode can be instructed when a predetermined traveling condition is satisfied regardless of operation of the mode select switch. That is, by automatically switching the mode select switch, the mode can be automatically switched instead of manually switching.

The positioning sensor 34 is, for example, a GPS sensor, receives a positioning signal transmitted from a GPS satellite, and measures an absolute position (latitude, longitude, and the like) of the vehicle 100 based on the received signal. The positioning sensor 34 includes not only the GPS sensor but also a sensor that performs positioning using radio waves transmitted from a quasi-zenith orbit satellite. A signal (a signal indicating a measurement result) from the positioning sensor 34 is transmitted to the controller 40.

The map database 35 is a device that stores general map data used in the navigation unit 36, and is constituted of, for example, a hard disk. The map data includes road position data, road shape (curvature or the like) data, along with intersection and road branch position data. The map data stored in the map database 35 is different from high-accuracy map data stored in a memory unit 42 of the controller 40.

The navigation unit 36 is a device that searches for a target route on a road to a destination input by a driver and provides guidance along the target route. The input of the destination and the guidance along the target route are performed via the input-output unit 33. The target route is calculated based on a current position of the vehicle 100 measured by the positioning sensor 34 and the map data stored in the map database 35.

The communication unit 37 communicates with various servers not illustrated via a network (for example, a communication network 30 to be described later) including a wireless communication network such as an Internet, and acquires the map data, traffic data, and the like from the server periodically or at an arbitrary timing. The acquired map data is output to the map database 35 and the memory unit 42, and the map data is updated. The acquired traffic data includes traffic congestion data and traffic light data such as a remaining time until a traffic light changes from red light to green light.

The actuators 38 are devices for operating various devices related to traveling operation of the vehicle 100. That is, the actuators 38 are actuators for traveling. The actuators 38 include a throttle actuator that adjusts the opening degree (throttle opening) of the throttle valve 11 of the engine 1 illustrated in FIG. 1, a shift actuator that changes the shift stage of the transmission 2 by controlling the flow of oil to the engagement element 21, a brake actuator that actuates a brake device, a steering actuator that drives a steering device, and the like.

The controller 40 includes an electronic control unit (ECU). Although a plurality of ECUs having different functions such as an engine control ECU and a transmission control ECU can be separately provided, in FIG. 2, the controller 40 is illustrated as a set of these ECUs for convenience. The controller 40 includes a computer including a processing unit 41 such as a CPU, a memory unit 42 such as a ROM, a RAM, and a hard disk drive, and other peripheral circuits (not illustrated).

The memory unit 42 stores highly accurate detailed map data including data on a center position of a lane, data on a boundary of a lane position, and the like. More specifically, road data, traffic regulation data, address data, facility data, telephone number data, and other data are stored as the map data. The road data includes data indicating the type of road such as a highway, a toll road, and a national highway, and data such as the number of lanes of a road, the width of each lane, a road gradient, a three-dimensional coordinate position of the road, a curvature of a curve of the lane, positions of the merging point and branch point of the lane, a road sign, and the presence or absence of a median strip. The traffic regulation data includes data indicating that traveling on a lane is restricted or a road is closed due to construction or the like. The memory unit 42 also stores data such as a shift map (shift diagram) serving as a reference of shift operation, various control programs, and a threshold used in the programs.

The processing unit 41 includes a subject vehicle position recognition unit 43, an exterior recognition unit 44, an action plan generation unit 45, and a driving control unit 46 as functional configurations related to automatic travel.

The subject vehicle position recognition unit 43 recognizes the position (subject vehicle position) of the vehicle 100 on a map based on the position data of the vehicle 100 received by the positioning sensor 34 and the map data of the map database 35. The subject vehicle position may be recognized using the map data (building shape data and the like) stored in the memory unit 42 and the peripheral information of the vehicle 100 detected by the external sensor group 31, thereby the subject vehicle position can be recognized with high accuracy. When the subject vehicle position can be measured by a sensor installed on the road or outside a road side, the subject vehicle position can be recognized with high accuracy by communicating with the sensor via the communication unit 37.

The exterior recognition unit 44 recognizes external circumstances around the vehicle 100 based on the signal from the external sensor group 31 such as a LIDAR, a radar, and a camera. For example, the position, speed, and acceleration of a surrounding vehicle (a preceding vehicle or a rear vehicle) traveling around the vehicle 100, the position of a surrounding vehicle stopped or parked around the vehicle 100, and the positions and states of other objects are recognized. Other objects include signs, traffic lights, road boundaries, road stop lines, buildings, guardrails, power poles, signboards, pedestrians, bicycles, and the like. The states of other objects include a color of a traffic light (red, green, yellow), the moving speed and direction of a pedestrian or a bicycle, and the like.

The action plan generation unit 45 generates a driving path (target path) of the vehicle 100 from a present time point to a predetermined time ahead based on, for example, the target route calculated by the navigation unit 36, the subject vehicle position recognized by the subject vehicle position recognition unit 43, and the external circumstances recognized by the exterior recognition unit 44. When there are a plurality of trajectories that are candidates for the target path on the target route, the action plan generation unit 45 selects, from among the plurality of trajectories, an optimal path that satisfies criteria such as compliance with laws and regulations and efficient and safe traveling, and sets the selected path as the target path. Then, the action plan generation unit 45 generates an action plan corresponding to the generated target path.

The action plan includes travel plan data set for each unit time Δt (for example, 0.1 seconds) from a present time point to a predetermined time T (for example, 5 seconds) ahead, that is, travel plan data set in association with a time for each unit time Δt. The travel plan data includes position data of the vehicle 100 and vehicle state data for each unit time. The position data is, for example, data of a target point indicating a two-dimensional coordinate position on the road, and the vehicle state data is vehicle speed data indicating the vehicle speed, direction data indicating the direction of the vehicle 100, or the like. The travel plan is updated every unit time.

The action plan generation unit 45 generates the target path by connecting the position data for each unit time Δt from the present time point to the predetermined time T ahead in time order. At this time, the acceleration (target acceleration) for each unit time Δt is calculated based on the vehicle speed (target vehicle speed) of each target point for each unit time Δt on the target path. That is, the action plan generation unit 45 calculates the target vehicle speed and the target acceleration. The target acceleration may be calculated by the driving control unit 46.

When the action plan generation unit 45 generates the target path, the action plan generation unit 45 first determines a travel mode. Specifically, the travel mode is determined, such as following traveling for following a preceding vehicle, overtaking traveling for overtaking a preceding vehicle, lane change traveling for changing a traveling lane, merging traveling for merging into a main line of a highway or a toll road, lane keeping traveling for keeping the lane so as not to deviate from the traveling lane, constant speed traveling, deceleration traveling, or acceleration traveling. Then, the target path is generated based on the travel mode.

In the self-drive mode, the driving control unit 46 controls each of the actuators 38 so that the vehicle 100 travels along the target path generated by the action plan generation unit 45. That is, the throttle actuator, the shift actuator, the brake actuator, the steering actuator, and the like are controlled so that the vehicle 100 passes through a target point P for each unit time.

More specifically, the driving control unit 46 calculates a requested driving force for obtaining the target acceleration for each unit time calculated by the action plan generation unit 45 in consideration of travel resistance determined by a road gradient or the like in the self-drive mode. Then, for example, the actuators 38 are feedback controlled so that an actual acceleration detected by the internal sensor group 32 becomes the target acceleration. That is, the actuators 38 are controlled so that the vehicle 100 travels at the target vehicle speed and the target acceleration. In the manual drive mode, the driving control unit 46 controls each of the actuators 38 in accordance with a travel command (accelerator opening or the like) from the driver acquired by the internal sensor group 32.

Meanwhile, when an emergency vehicle 200 such as a police car travels urgently, data indicating the current position and planned travel route of the emergency vehicle 200 is transmitted from the emergency vehicle 200 to surrounding vehicles. The vehicle 100 notifies an occupant of the vehicle 100 of an approach of the emergency vehicle 200 via a display device such as a liquid crystal display or an audio output device such as a speaker based on the data transmitted from the emergency vehicle 200. Accordingly, the occupant of vehicle 100 recognizes the approach of the emergency vehicle 200. When the vehicle 100 is traveling in the self-drive mode, the driving operation is performed according to a surrounding circumstances situation recognized by the occupant to move the vehicle 100 to an end of a road 301 or temporarily stop the vehicle 100. In this way, the vehicle 100 avoids the emergency vehicle 200. When the vehicle 100 is traveling in the self-drive mode, the vehicle 100 avoids the emergency vehicle 200 based on the data transmitted from the emergency vehicle 200.

However, there is a case where it is not desired to notify the occupant of the surrounding vehicle of the approach of the emergency vehicle 200 depending on the type of the emergency vehicle 200 and a situation during emergency travel. For example, in a case where a police car tracks a criminal escaping in a vehicle, if the current position or the planned travel route of the police car is notified to the criminal, there is a possibility that the criminal escapes. In order to solve such a problem, in the present embodiment, the vehicle control system 10 is configured as follows.

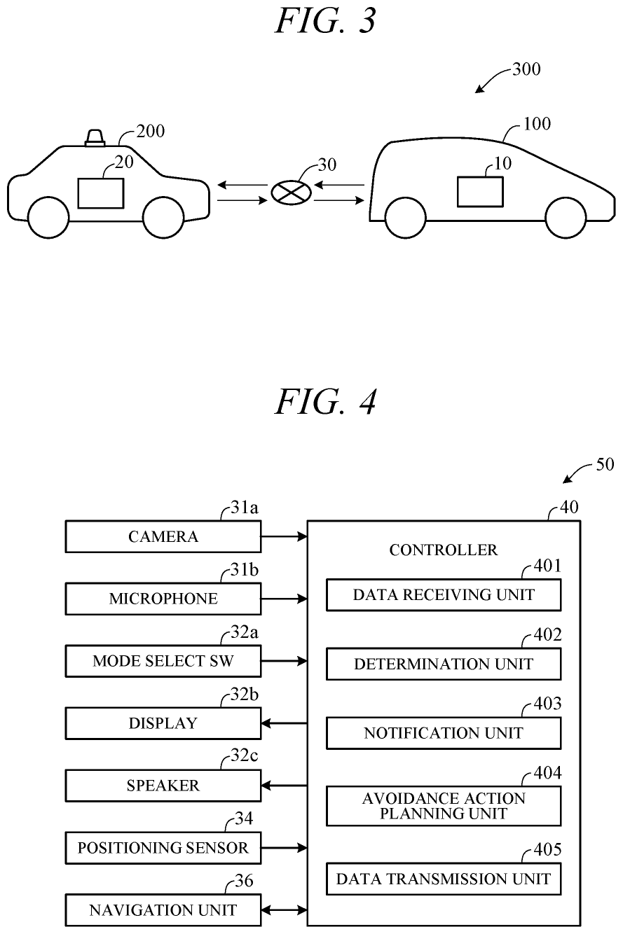

FIG. 3 is a diagram illustrating an example of a vehicle avoidance system 300 including the vehicle control system 10 according to the present embodiment. As illustrated in FIG. 3, the vehicle avoidance system 300 includes the vehicle control system 10 mounted on the vehicle 100 and an in-vehicle apparatus 20 mounted on the emergency vehicle 200. The vehicle control system 10 and the in-vehicle apparatus 20 are connected to the communication network 30 and are configured to be able to communicate with each other via the communication network 30. The communication network 30 includes a vehicle-to-vehicle communication network, a vehicle-to-infrastructure communication network, and the like. The communication network 30 may include a public wireless communication network represented by the Internet network, a mobile phone network, or the like, or a closed communication network provided for each predetermined management region, for example, a wireless LAN. Although FIG. 3 illustrates the single vehicle 100 and the single emergency vehicle 200, the vehicle avoidance system 300 may include a plurality of the vehicle control systems 10 mounted on a plurality of the vehicles 100 and a plurality of the in-vehicle apparatus 20 mounted on a plurality of the emergency vehicles 200.

FIG. 4 is a block diagram illustrating a configuration of a substantial part of a vehicle notification apparatus according to the present embodiment. The vehicle notification apparatus notifies the occupant of vehicle 100 of the approach of the emergency vehicle 200, and constitutes a part of the vehicle control system 10 in FIG. 2. The vehicle avoidance system 300 including the vehicle control system 10 and the in-vehicle apparatus 20 partially configured by the vehicle notification apparatus may be referred to as a vehicle notification system.

As illustrated in FIG. 4, the vehicle notification apparatus 50 includes the controller 40, a camera 31a, a microphone 31b, a mode select switch 32a, a display 32b, a speaker 32c, the positioning sensor 34, and the navigation unit 36 each connected to the controller 40.

The controller 40 includes, as functional configurations, a data receiving unit 401, a determination unit 402, a notification unit 403, an avoidance action planning unit 404, and a data transmission unit 405.

The data receiving unit 401 receives vehicle data including position data indicating the current position of the emergency vehicle 200, speed data indicating the vehicle speed of the emergency vehicle 200, and the like transmitted from the emergency vehicle 200 via the communication unit 37. The vehicle data may include vehicle type data indicating the type (for example, a police car, a fire engine, or an ambulance) of the emergency vehicle 200, emergency data indicating a purpose of the emergency travel, and the like, in addition to the position data and the speed data. The data transmission unit 405 transmits data indicating the current position of the vehicle 100 detected by the positioning sensor 34, the speed of the vehicle 100 detected by the vehicle speed sensor, and the like to the in-vehicle apparatus 20 via the communication unit 37. Communication with the in-vehicle apparatus 20 may be vehicle-to-vehicle communication, vehicle-to-infrastructure communication, or other communication.

The determination unit 402 determines whether or not the emergency vehicle 200 is approaching the vehicle 100 based on the position of the vehicle 100 recognized by the subject vehicle position recognition unit 43 and the position of the emergency vehicle 200 indicated by the position data acquired by the data receiving unit 401. Specifically, when a distance between the vehicle 100 and the emergency vehicle 200 is equal to or less than a preset first predetermined value, it is determined that the emergency vehicle 200 is approaching the vehicle 100. The determination unit 402 may determine whether or not the emergency vehicle 200 is approaching the vehicle 100 based on a siren (for example, change in frequency of a sound of the siren) of the emergency vehicle 200 input to the microphone 31b.

When the determination unit 402 receives a notification disapproval command transmitted from the emergency vehicle 200 via the communication unit 37, the determination unit 402 determines whether or not to permit the notification by the notification unit 403 based on the notification disapproval command. The notification disapproval command is a command indicating that the notification of the approach of the emergency vehicle 200 and the position of the emergency vehicle 200 to the occupant are not permitted.

The determination unit 402 may determine the type of the emergency vehicle 200 and the purpose of the emergency travel based on the vehicle data of the emergency vehicle 200 received by the data receiving unit 401, and determine whether or not to permit the notification by the notification unit 403. For example, when the emergency vehicle 200 is a police car and is tracking a criminal, the notification unit 403 may determine not to permit the notification by the notification unit 403. As a result, even when the notification disapproval command is not transmitted from the emergency vehicle 200 or the notification disapproval command transmitted from the emergency vehicle 200 is not received for some reason, it is possible to suitably determine whether or not to permit the notification by the notification unit 403. The notification unit 403 may determine to permit the notification by the notification unit 403 when the emergency vehicle 200 is traveling urgently toward the destination for relief for an accident, a disaster, or the like. The determination unit 402 may recognize the type of the siren of the emergency vehicle 200 input to the microphone 31b and determine the type of the emergency vehicle 200 based on the type of the siren.

The notification unit 403 notifies the occupant of the vehicle 100 of approach information of the emergency vehicle 200 via the display 32b and the speaker 32c. The approach information includes approach notification information for notifying the approach of the emergency vehicle 200 and the position data of the emergency vehicle 200. Specifically, when the determination unit 402 determines that the emergency vehicle 200 is approaching the vehicle 100 and the determination unit 402 determines to permit the notification of the approach information, the notification unit 403 outputs the approach information of the emergency vehicle 200 to the display 32b and the speaker 32c. The notification unit 403 may output the approach information to either the display 32b or the speaker 32c.

When the distance between the vehicle 100 and the emergency vehicle 200 is equal to or less than a preset second predetermined value, the notification unit 403 notifies the approach information even when the determination unit 402 determines not to permit the notification of the approach information. The second predetermined value is a value smaller than the first predetermined value. When the emergency vehicle 200 is in the immediate vicinity of the vehicle 100, the vehicle 100 needs to avoid the emergency vehicle 200. Therefore, when the distance to the emergency vehicle 200 is equal to or less than the second predetermined value as described above, the approach information is notified regardless of the determination result of the determination unit 402. The first predetermined value is a distance (for example, 50 meters) sufficient to avoid the emergency vehicle 200, and the second predetermined value is such a distance (for example, 5 meters) that traveling of the emergency vehicle 200 is hindered unless the vehicle 100 performs avoidance operation immediately (immediately after it is determined that the emergency vehicle 200 approaches the vehicle 100).

The determination unit 402 determines whether or not to permit notification of the position data of the emergency vehicle 200 based on the notification disapproval command transmitted from the emergency vehicle 200. For example, when the notification disapproval command includes a command not to permit the notification of the position data of the emergency vehicle 200, the notification unit 403 notifies the approach notification information without notifying the position data of the emergency vehicle 200.

In addition, when the vehicle 100 is traveling in the self-drive mode, the notification unit 403 notifies the approach information of the emergency vehicle 200 even when the determination unit 402 determines not to permit the notification of the approach information.

When the determination unit 402 determines that the emergency vehicle 200 is approaching the vehicle 100 while the vehicle 100 is traveling by self-driving, the avoidance action planning unit 404 generates an action plan of the vehicle 100 so that the vehicle 100 avoids the emergency vehicle 200. The avoidance action planning unit 404 constitutes, for example, a part of the action plan generation unit 45 in FIG. 2.

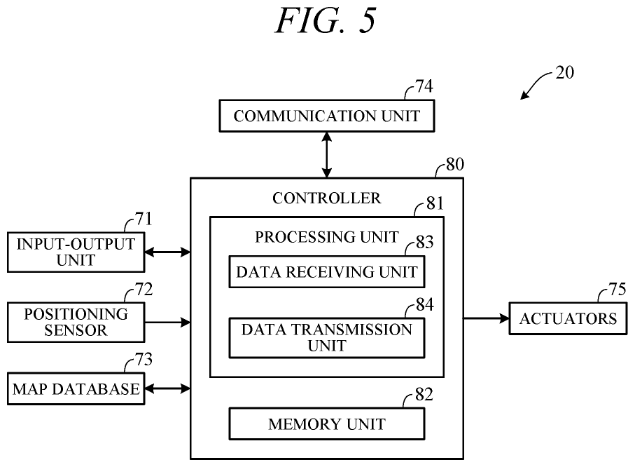

FIG. 5 is a block diagram schematically illustrating an overall configuration of the in-vehicle apparatus 20 of the emergency vehicle 200 in FIG. 3. As illustrated in FIG. 5, the in-vehicle apparatus (hereinafter also referred to as the notification command apparatus) 20 mainly includes a controller 80, an input-output unit 71, a positioning sensor 72, a map database 73, a communication unit 74, and actuators (actuators for traveling) 75 each electrically connected to the controller 80.

The controller 80 includes the ECU. Although a plurality of ECUs having different functions such as an engine control ECU and a transmission control ECU can be separately provided, in FIG. 5, the controller 80 is illustrated as a set of these ECUs for convenience as in FIG. 2. The controller 80 includes a computer including a processing unit 81 such as a CPU, a memory unit 82 such as a ROM, a RAM, and a hard disk drive, and other peripheral circuits (not illustrated). The memory unit 82 also stores data such as various control programs and a threshold used in the programs.

The processing unit 81 includes a data receiving unit 83 and a data transmission unit 84 as functional configurations. The data receiving unit 83 receives the position data indicating the current position of the vehicle 100 transmitted from the vehicle 100 via the communication unit 74. The data transmission unit 84 transmits, to the vehicle 100 via the communication unit 74, data indicating the position of the emergency vehicle 200 measured by the positioning sensor 72, the vehicle speed of the emergency vehicle 200 detected by the vehicle speed sensor (not illustrated), and the like. The data transmission unit 84 transmits the notification disapproval command to the vehicle notification apparatus 50 via the communication unit 74. Communication with the vehicle 100 via the communication unit 74 may be vehicle-to-vehicle communication, vehicle-to-infrastructure communication, or other communication.

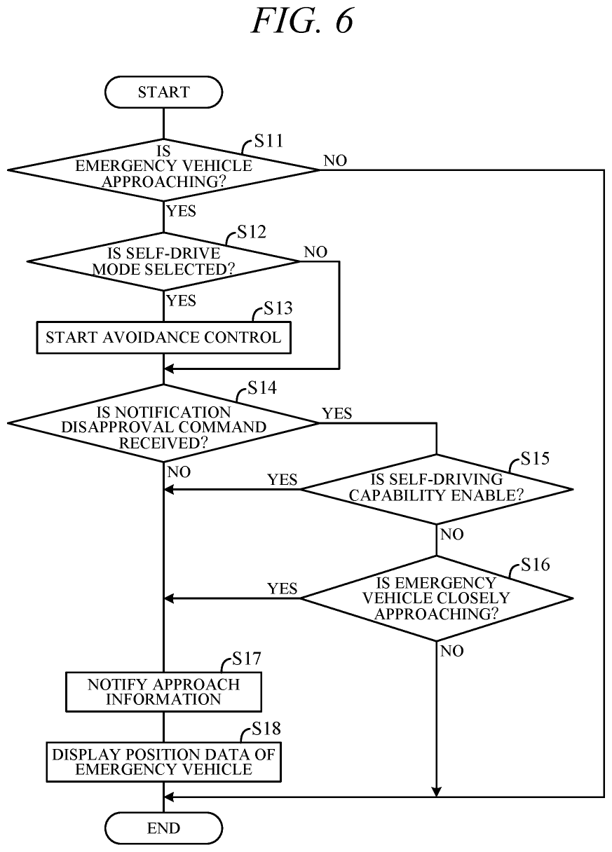

FIG. 6 is a flowchart showing an example of processing executed by the CPU of the controller 40 in FIG. 4 according to a program stored in the memory unit 42 in advance. The processing illustrated in the flowchart is started, for example when the controller 40 is powered on, and is repeated at a predetermined cycle.

First, in S11 (S: process step), it is determined whether or not the emergency vehicle 200 is approaching the vehicle 100 based on the position of the vehicle 100 recognized by the subject vehicle position recognition unit 43 and the position of the emergency vehicle 200 indicated by the position data acquired by the data receiving unit 401. Specifically, when the distance between the vehicle 100 and the emergency vehicle 200 is equal to or less than the first predetermined value, it is determined that the emergency vehicle 200 is approaching the vehicle 100. If the result in S11 is NO, the processing ends.

If the result in S11 is YES, it is determined in S12 whether or not the self-drive mode is selected by the mode select switch (not illustrated), that is, whether or not the self-driving capability is enabled. If the result in S12 is YES, control (hereinafter referred to as avoidance control) for avoiding the emergency vehicle 200 is started in S13. More specifically, the action plan is generated such that the vehicle 100 travels along such a route that does not obstruct passage of the emergency vehicle 200, and the actuators 38 are controlled based on the generated action plan. If the result in S12 is NO, the processing proceeds to S14.

In S14, it is determined whether or not the notification disapproval command is received from the emergency vehicle 200. If the result in S14 is NO, the processing proceeds to S17. If the result in S14 is YES, it is determined in S15 whether or not the self-driving capability is enabled. If the result in S15 is YES, the processing proceeds to S17. When the result in S15 is NO, it is determined in S16 whether or not a degree of approach of the emergency vehicle 200 to the vehicle 100 is equal to or more than a predetermined degree, that is, whether or not the emergency vehicle 200 is approaching the immediate vicinity of the vehicle 100. More specifically, it is determined whether or not the distance between the vehicle 100 and the emergency vehicle 200 is equal to or less than the second predetermined value. If the result in S16 is YES, the processing proceeds to S17. If the result in S16 is NO, the processing ends.

In S17, the approach information of the emergency vehicle 200 is notified to the occupant of the vehicle 100 via the input-output unit 33. For example, character data indicating the approach of the emergency vehicle 200 is output to a display device such as a liquid crystal display. In addition, for example, voice data indicating the approach of the emergency vehicle 200 is output to a voice output device such as a speaker. In S18, the position data of the emergency vehicle 200 is displayed. More specifically, the position data of the emergency vehicle 200 is output to a display device such as a liquid crystal display together with the map data.

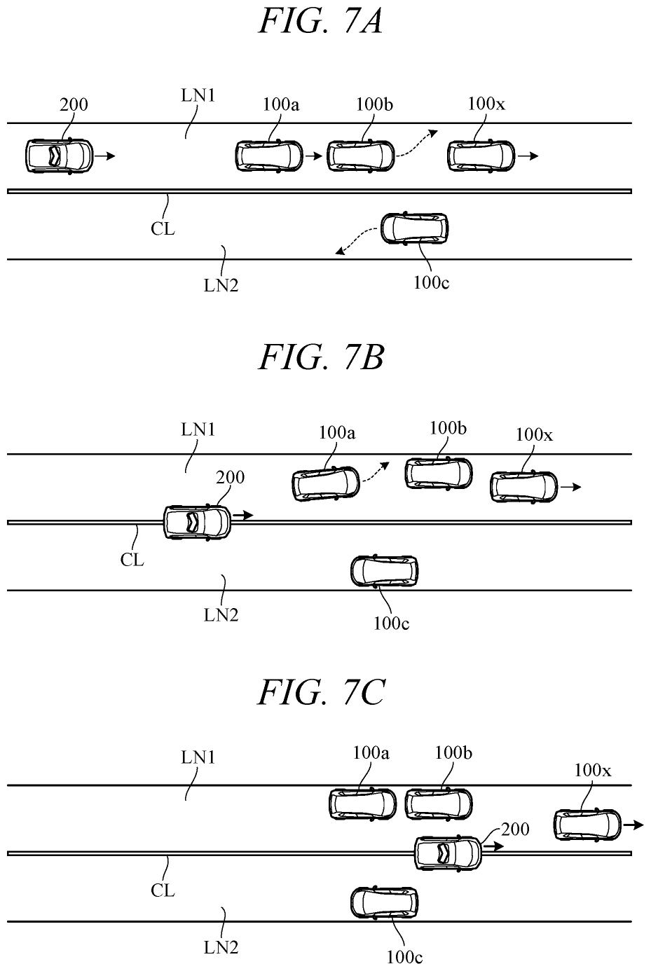

The operation of the vehicle notification apparatus 50 according to the present embodiment is summarized as follows. FIGS. 7A to 7C are diagrams schematically illustrating a state in which the police car 200, which is an emergency vehicle, is tracking an escaping vehicle 100x on which the criminal rides. FIG. 7A illustrates a road having one lane on one side of left-hand traffic, and the escaping vehicle 100x is traveling in a lane LN1. A vehicle 100a and a vehicle 100b are traveling behind (the left side in the figure) the escaping vehicle 100x, and the police car 200 is further traveling behind. A vehicle 100c is traveling in a lane LN2 which is an opposite lane. A line CL in the figure represents a center line. It is assumed that the escaping vehicle 100x and the vehicle 100a are traveling in the manual drive mode, and the vehicle 100b and the vehicle 100c are traveling in the self-drive mode.

The police car 200 tracks the escaping vehicle 100x while transmitting the notification disapproval command at a predetermined cycle so that the presence of the own vehicle is not known to the criminal in the escaping vehicle 100x. Therefore, in the escaping vehicle 100x and the vehicle 100a that are traveling in the manual drive mode, even if the approach of the police car 200 is detected (S11), the approach information of the police car 200 is not notified to the occupant until the police car 200 is in the immediate vicinity (S14, S15, S16). On the other hand, in the vehicle 100b and the vehicle 100c traveling in the self-drive mode, when the approach of the police car 200 is detected (S11), the control for avoiding the police car 200 is started (S12, S13). As a result, the vehicle 100b and the vehicle 100c start to move to a road shoulder (avoidance operation) so as to avoid the police car 200, as illustrated in FIG. 7A. A solid arrow in the figure indicates that the vehicle is traveling, and a broken arrow indicates that the vehicle has started the avoidance operation. In the vehicle 100b and the vehicle 100c, even when the notification disapproval command is received, the occupant is notified of the approach information of the police car 200 (S15, S17, S18).

FIG. 7B illustrates a state in which a distance between the police car 200 and the vehicle 100a traveling in the manual drive mode becomes equal to or less than the second predetermined value. In the vehicle 100a traveling in the manual drive mode, when the police car 200 approaches the immediate vicinity of the vehicle 100a, the occupant is notified of the approach information of the emergency vehicle (S16, S17, S18). As described above, in the vehicle 100a traveling in the manual drive mode, even when the notification disapproval command is received, when the police car 200 is in the immediate vicinity, the occupant is notified of the approach information. When the approach information is notified, the occupant of the vehicle 100a avoids the police car 200 by performing the driving operations such as an accelerator operation, a brake operation, and steering. As a result, as illustrated in FIG. 7C, a course of the police car 200 is secured.

Similarly, in the escaping vehicle 100x, when the distance to the police car 200 becomes equal to or less than a predetermined value, the occupant (criminal) is notified of the approach information. However, at that time, since the police car 200 has already approached the escaping vehicle 100x as illustrated in FIG. 7C, the police car 200 can catch up with the escaping vehicle 100x.

According to the embodiment of the present invention, the following functions and effects can be obtained.

(1) The vehicle notification apparatus 50 notifies the occupant of the vehicle 100 of the approach of the emergency vehicle. The vehicle notification apparatus 50 includes the positioning sensor 34 that detects the position of the vehicle 100, the data receiving unit 401 that acquires the position data of the emergency vehicle 200, the determination unit 402 that determines whether or not the emergency vehicle 200 is approaching the vehicle 100 based on the position detected by the positioning sensor 34 and the position data acquired by the data receiving unit 401, and the notification unit 403 that notifies the approach information of the emergency vehicle 200. The determination unit 402 further determines whether or not to permit the notification by the notification unit 403 based on the command transmitted from the emergency vehicle 200. When the determination unit 402 determines that the emergency vehicle 200 is approaching the vehicle 100 and the determination unit 402 determines to permit the notification of the approach information, the notification unit 403 notifies the occupant of the approach information of the emergency vehicle 200. On the other hand, when the determination unit 402 determines not to permit the notification of the approach information, the notification unit 403 does not notify the approach information even if the determination unit 402 determines that the emergency vehicle 200 is approaching.

As a result, the emergency vehicle 200 can prevent the occupant of the surrounding vehicle from recognizing the approach and position of the emergency vehicle 200. Therefore, when the emergency vehicle 200 tracks the criminal escaping in the vehicle, the approach and position of the emergency vehicle 200 can be prevented from being recognized by the criminal, and it is possible to prevent the criminal from escaping from the tracking of the emergency vehicle 200.

(2) The determination unit 402 further determines the type of the emergency vehicle 200, and determines whether or not to permit the notification by the notification unit 403 based on the determined type of the emergency vehicle 200. Specifically, when the determination unit 402 determines that the emergency vehicle 200 is a predetermined emergency vehicle, the determination unit 402 does not permit the notification by the notification unit 403. As a result, when the emergency vehicle 200 is a predetermined emergency vehicle (for example, a police car), the occupant of the vehicle around the emergency vehicle 200 is not notified of the approach and position of the emergency vehicle 200. Thus, for example, even if the police car approaches the vehicle of the criminal who is being tracked, the criminal who is being tracked does not know the approach and position of the police car. On the other hand, when the emergency vehicle 200 is an emergency vehicle (for example, a fire engine or an ambulance) other than a predetermined emergency vehicle, the occupant of the vehicle around the emergency vehicle 200 is notified of the approach and position of the emergency vehicle 200. As a result, when the emergency vehicle is a fire engine or an ambulance used for the purpose of rescuing an accident, a disaster, or the like, the occupant of the surrounding vehicle is notified of the approach and position of the emergency vehicle 200. As a result, the surrounding vehicle can quickly avoid the emergency vehicle, and the course of the emergency vehicle can be quickly secured.

(3) The notification unit 403 notifies of the approach information including the approach notification information for notifying the approach of the emergency vehicle 200 and the position data of the emergency vehicle 200 acquired by the data receiving unit 401. Based on the command transmitted from the emergency vehicle 200, the determination unit 402 determines whether or not to permit the notification of the approach notification information by the notification unit 403 and whether or not to permit the notification of the position data of the emergency vehicle 200 by the notification unit 403. When the determination unit 402 determines not to permit the notification of the position data of the emergency vehicle 200, the notification unit 403 further does not notify the position data of the emergency vehicle 200. As a result, when the emergency vehicle 200 tracks the criminal escaping in the vehicle, it is possible to track the vehicle of the criminal while calling attention to the approach to the occupants of the surrounding vehicles.

(4) The determination unit 402 determines the distance between the vehicle 100 and the emergency vehicle 200 based on the position detected by the positioning sensor 34 and the position data acquired by the data receiving unit 401. When the distance between the vehicle 100 and the emergency vehicle 200 is equal to or less than the first predetermined value, the determination unit 402 determines that the emergency vehicle 200 is approaching the vehicle 100. When the distance between the vehicle 100 and the emergency vehicle 200 is equal to or less than the second predetermined value smaller than the first predetermined value, the notification unit 403 notifies the approach information even when the determination unit 402 determines not to permit the notification of the approach information. As described above, even when the notification of the approach information is not permitted, by notifying the occupant of the vehicle 100 of the approach of the emergency vehicle 200 when the emergency vehicle 200 approaches the immediate vicinity of the vehicle 100, the occupant of the vehicle 100 can perform the driving operation for avoiding the emergency vehicle 200. Thus, it is possible to prevent the vehicle 100 from obstructing the passage of the emergency vehicle 200. As a result, when the emergency vehicle 200 tracks the criminal escaping in the vehicle, the emergency vehicle 200 can more smoothly approach the immediate vicinity of the escaping vehicle.

(5) The avoidance action planning unit 404 (action plan generation unit 45) that generates the action plan of the vehicle 100 is further provided. The vehicle 100 is a vehicle having the self-driving capability of traveling by self-driving according to the action plan generated by the action plan generation unit 45. When the determination unit 402 determines that the emergency vehicle 200 is approaching while the vehicle 100 is traveling by self-driving, the action plan generation unit 45 generates the action plan of the vehicle 100 so that the vehicle 100 avoids the emergency vehicle 200. As a result, when the emergency vehicle 200 approaches the vehicle 100 traveling in the self-drive mode, the vehicle 100 can avoid the emergency vehicle 200 even if the occupant of the vehicle 100 is not notified of the approach of the emergency vehicle 200.

(6) When the vehicle 100 is traveling by self-driving, the notification unit 403 notifies the approach information of the emergency vehicle 200 even when the determination unit 402 determines not to permit the notification of the approach information. Even if the vehicle of the criminal has the self-driving capability, since it is assumed that the vehicle is set to the manual drive mode and the criminal performs the driving operation by himself/herself while escaping, it is determined that the vehicle is not escaping while traveling in the self-drive mode, and the notification of the approach information of the emergency vehicle 200 is permitted.

(7) The vehicle notification system 300 includes the vehicle notification apparatus 50 and the in-vehicle apparatus 20 that transmits, to the vehicle notification apparatus 50, a command for causing the vehicle notification apparatus 50 to execute the notification of the approach of the emergency vehicle 200 (FIGS. 3 and 4). As a result, it is possible to prevent the occupant of the surrounding vehicle from recognizing the approach and position of the emergency vehicle 200 during the emergency travel. Therefore, when the emergency vehicle 200 tracks the criminal escaping in the vehicle, the approach of the emergency vehicle 200 can be prevented from being recognized by the criminal, and it is possible to prevent the criminal from escaping from the tracking of the emergency vehicle 200.

In the above embodiment, although the data receiving unit 401 acquires the position data of the emergency vehicle 200 from the emergency vehicle 200 via the communication unit 37, a configuration of a position data acquisition unit of the vehicle notification apparatus is not limited to that described above. For example, the position data acquisition unit of the vehicle notification apparatus may acquire the position data of the emergency vehicle 200 from a roadside apparatus of a vehicle-to-infrastructure communication system via the communication unit 37.

In the above embodiment, the determination unit 402 determines whether or not the emergency vehicle 200 is approaching the vehicle 100 based on the position of the vehicle 100 detected by the positioning sensor 34 and the position data acquired by the data receiving unit 401. However, a configuration of an approach determination unit of the vehicle notification apparatus is not limited to that described above. For example, the approach determination unit of the vehicle notification apparatus may determine whether or not the emergency vehicle 200 is approaching the vehicle 100 based on data received from the roadside apparatus of the vehicle-to-infrastructure communication system via the communication unit 37. In the above embodiment, although the determination unit 402 determines whether or not to permit the notification by the notification unit 403 based on the notification disapproval command transmitted from the emergency vehicle 200, a configuration of a notification determination unit is not limited to that described above. For example, the notification determination unit may determine whether or not to permit notification by the notification unit 403 based on a notification permission command transmitted from the emergency vehicle 200 and indicating the approach of the emergency vehicle 200 and the permission of the notification to the occupant at the position of the emergency vehicle 200. That is, the data transmission unit 84 of the in-vehicle apparatus 20 may transmit a notification approval command instead of the notification disapproval command as a notification command unit. the notification determination unit may determine whether or not the notification permission command is received, permit the notification by the notification unit 403 when the notification permission command is received, and not permit the notification by the notification unit 403 when the notification permission command is not received.

In the above embodiment, although the determination unit 402 determines the type of the emergency vehicle 200 and the purpose of the emergency travel, a configuration of a type determination unit is not limited to that described above. For example, the type determination unit may determine the type of the emergency vehicle 200 based on an image captured by the camera 31a.

In addition, in the above embodiment, although the vehicle notification apparatus 50 is applied to the vehicle control system of a self-driving vehicle, the vehicle notification apparatus 50 is also applicable to vehicles other than the self-driving vehicle. For example, the vehicle notification apparatus 50 can also be applied to a manually driven vehicle including ADAS (advanced driver-assistance systems).

There is a case where the emergency vehicle 200 or an occupant of the emergency vehicle 200 requests a vehicle around the emergency vehicle 200 to perform the avoidance operation by voice via a speaker or the like. On the other hand, the vehicle 100 may be configured to control the traveling operation of the subject vehicle so as to follow the avoidance operation of a preceding vehicle and a following vehicle when the emergency vehicle 200 is detected during traveling in the self-drive mode.

At this time, when the avoidance operation requested by voice from the emergency vehicle 200 or the occupant of the emergency vehicle 200 is different from the avoidance operation of the preceding vehicle and the following vehicle, there is a possibility that the vehicle 100 cannot suitably avoid the emergency vehicle 200. Thus, in the present embodiment, the vehicle control system 10 is configured such that the controller 40 (processing unit 41) performs the following processing when an avoidance action is requested by voice from the emergency vehicle 200 or the occupant of the emergency vehicle 200.

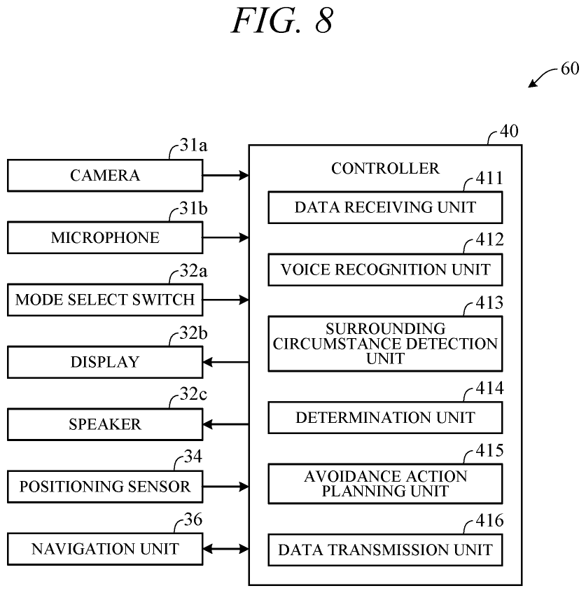

FIG. 8 is a block diagram illustrating a configuration of main components of a vehicle control apparatus according to the present embodiment. This vehicle control apparatus controls the traveling operation of the vehicle 100 to avoid the emergency vehicle 200, and constitutes a part of the vehicle control system 10 of FIG. 2.

As illustrated in FIG. 8, a vehicle control apparatus 60 includes the controller 40, the camera 31a, the microphone 31b, the mode select switch 32a, the display 32b, the speaker 32c, the positioning sensor 34, and the navigation unit 36 each connected to the controller 40. The controller 40 includes, as functional configurations, a data receiving unit 411, a voice recognition unit 412, a surrounding circumstance detection unit 413, a determination unit 414, an avoidance action planning unit 415, and a data transmission unit 416.

The data receiving unit 411 receives the position data indicating the current position of the emergency vehicle 200, the speed data indicating the speed of the emergency vehicle 200, and the like transmitted from the emergency vehicle 200 via the communication unit 37. Furthermore, the data receiving unit 411 receives the command transmitted from the emergency vehicle 200. The data transmission unit 416 transmits, via the communication unit 37, the position data indicating the current position of the vehicle 100, data indicating the vehicle speed of the vehicle 100 detected by the vehicle speed sensor of the internal sensor group 32, and the like to the in-vehicle apparatus 20 of the emergency vehicle 200. Communication with the emergency vehicle 200 may be vehicle-to-vehicle communication, vehicle-to-infrastructure communication, or other communication.

The voice recognition unit 412 recognizes information included in a voice input to the microphone 31b. Specifically, the information (hereinafter referred to as the notification information) included in the voice emitted from an external speaker (not illustrated) of the emergency vehicle 200 or the occupant of the emergency vehicle 200 to the surrounding vehicle is recognized. The voice recognition unit 412 constitutes, for example, a part of the exterior recognition unit 44 in FIG. 2.

The surrounding circumstance detection unit 413 detects a surrounding circumstance of the vehicle 100. More specifically, the surrounding circumstance detection unit 413 detects a movement of the vehicle around the vehicle 100. The surrounding circumstance detection unit 413 voice recognition unit constitutes, for example, a part of the exterior recognition unit 44 in FIG. 2.

The determination unit 414 determines whether or not the vehicle 100 is within a predetermined range from an intersection based on the map data stored in the map database 35 and the position of the vehicle 100 recognized by the subject vehicle position recognition unit 43. In addition, the determination unit 414 determines whether or not the emergency vehicle 200 enters the intersection based on the voice input by the microphone 31b. More specifically, when the voice recognition unit 412 recognizes that the notification information from the emergency vehicle 200 includes information for notifying the entrance of the emergency vehicle 200 into the intersection, the determination unit 414 determines that the emergency vehicle 200 enters the intersection.

The information for notifying the entrance into the intersection is information for notifying the action of the emergency vehicle 200 near the intersection or in the intersection, such as “the vehicle will enter the intersection” and “the vehicle will turn right at the intersection”. The avoidance action planning unit 415 generates the action plan in response to the avoidance command. More specifically, when the voice recognition unit 412 recognizes that the avoidance command is included in the notification information, the avoidance action planning unit 415 generates the action plan in response to the avoidance command. The avoidance action planning unit 415 constitutes, for example, a part of the action plan generation unit 45 in FIG. 2.

When the determination unit 414 determines that the vehicle 100 is within the predetermined range from the intersection and the determination unit 414 determines that the emergency vehicle 200 enters the intersection, the avoidance action planning unit 415 generates the action plan to stop the vehicle 100.

When the avoidance command is included in the command from the emergency vehicle 200 received by the data receiving unit 411, the avoidance action planning unit 415 may generate the action plan in response to the avoidance command.

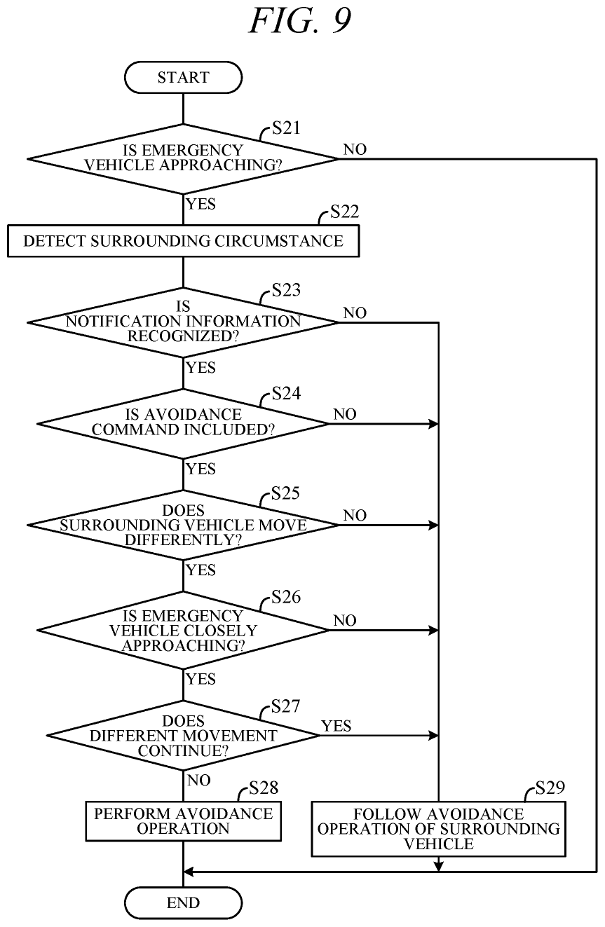

FIG. 9 is a flowchart illustrating an example of processing executed by the CPU of the controller 40 in FIG. 8 according to a program stored in the memory unit 42 in advance, particularly processing executed when the avoidance command from the emergency vehicle 200 or the occupant of the emergency vehicle 200 is included in the notification information recognized by the voice recognition unit 412. The processing illustrated in the flowchart is started, for example when the vehicle control apparatus 60 is powered on, and is repeated at a predetermined cycle.

First, in S21, it is determined whether or not the emergency vehicle 200 is approaching the vehicle 100 based on the position of the vehicle 100 recognized by the subject vehicle position recognition unit 43 and the position of the emergency vehicle 200 indicated by the position data acquired by the data receiving unit 411. Specifically, when the distance between the vehicle 100 and the emergency vehicle 200 is equal to or less than the first predetermined value, it is determined that the emergency vehicle 200 is approaching the vehicle 100. If the result in S21 is NO, the processing ends.

If the result in S21 is YES, the movement of the vehicle around the vehicle 100 is detected in S22. In S23, it is determined whether or not the notification information from the emergency vehicle 200 has been recognized. If the result in S23 is NO, the processing proceeds to S29. In S29, the action plan is generated so that the vehicle 100 travels following the avoidance operation of the surrounding vehicle, and the actuators 38 are controlled based on the generated action plan.

On the other hand, if the result in S23 is YES, it is determined in S24 whether or not the avoidance command is included in the notification information. If the result in S24 is NO, the processing proceeds to S29. If the result in S24 is YES, it is determined in S25 whether or not the movement of the vehicle around the vehicle 100 detected in S22 is different from the movement corresponding to the avoidance command. If the result in S25 is NO, the processing proceeds to S29. When the movement of the vehicle around the vehicle 100 is not detected in S22 because there is no other vehicle around the vehicle 100, the processing may proceed to S26.

When the result in S25 is YES, it is determined in S26 whether or not the degree of approach of the emergency vehicle 200 to the vehicle 100 is equal to or more than the predetermined degree, that is, whether or not the emergency vehicle 200 has approached the immediate vicinity of the vehicle 100. More specifically, it is determined whether or not the distance to the emergency vehicle 200 is equal to or less than the second predetermined value. If the result in S26 is NO, the processing proceeds to S29. When the emergency vehicle 200 is not in the vicinity of the vehicle 100, it is not necessary to follow the avoidance command from the emergency vehicle 200, and therefore, the traveling of the vehicle 100 is controlled to follow the avoidance operation of the surrounding vehicle until the distance from the emergency vehicle 200 becomes equal to or less than the second predetermined value.

If the result in S26 is NO, the processing proceeds to S29. If the result in S26 is YES, it is determined in S27 whether or not a state in which the movement of the vehicle around the vehicle 100 and the movement corresponding to the avoidance command are different continues for a certain period of time. For example, a time counter stored in the memory unit 42 is used to determine whether or not the state in which the movement of the surrounding vehicle and the movement corresponding to the avoidance command are different has continued for a certain period of time. The time counter is set to 0 when the vehicle control apparatus 60 is powered on. The time counter is incremented if the result in S25 is YES, and is set to 0 if the result in S25 is NO. In S27, when the time counter has reached a predetermined count value, it is determined that the state in which the movement of the surrounding vehicle and the movement corresponding to the avoidance command are different has continued for a certain period of time. At that time, the time counter is reset to 0. If the result in S27 is YES, the processing proceeds to S29. If the result in S27 is NO, the action plan is generated in S28 so that the vehicle 100 performs the traveling operation (avoidance operation) corresponding to the avoidance command, and the actuators 38 are controlled based on the generated action plan.

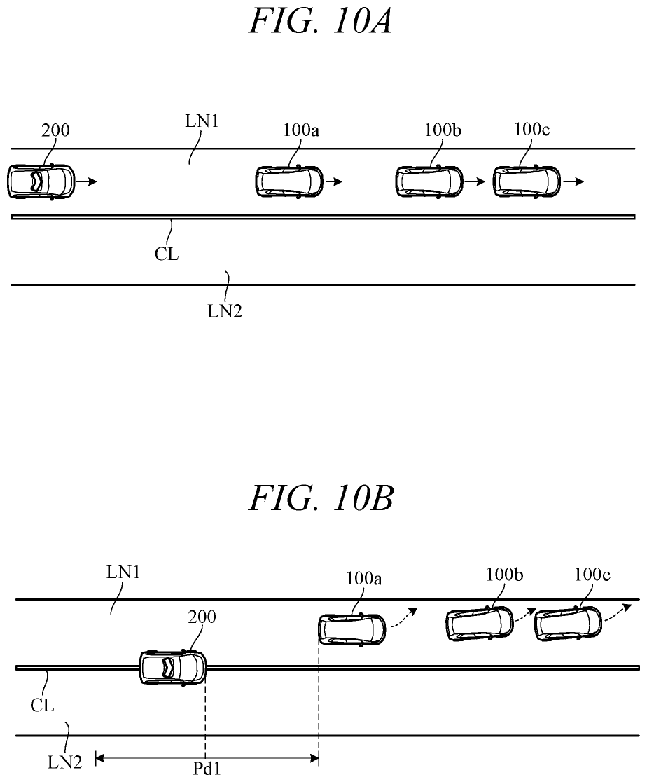

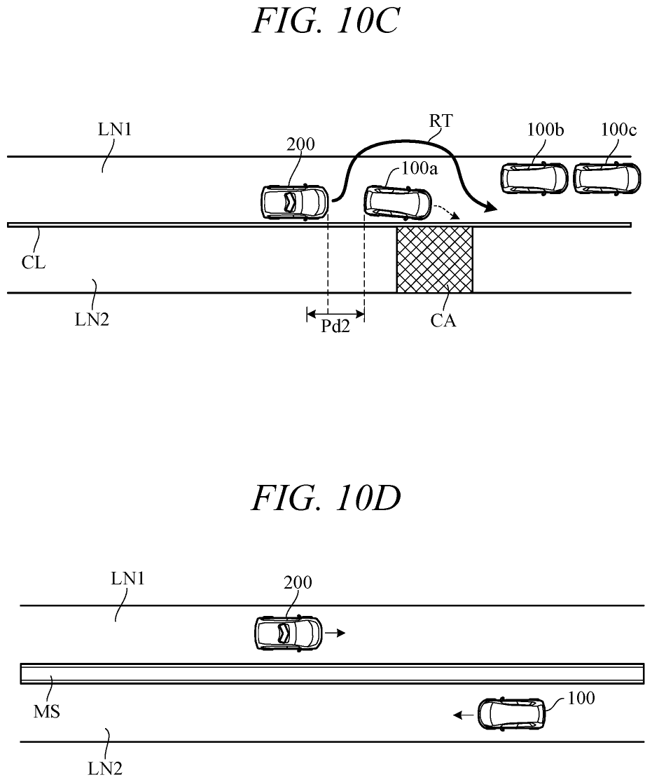

The operation of the vehicle control apparatus 60 according to the present embodiment is summarized as follows. FIGS. 10A to 10D illustrate a state in which the emergency vehicle 200 is urgently traveling on a road having one lane on one side of left-hand traffic. In FIGS. 10A to 10C, it is assumed that the occupant of the emergency vehicle 200 gives the avoidance command to the surrounding vehicle by voice via a loudspeaker or an external speaker (not illustrated) of the emergency vehicle 200. The avoidance command is a command that urges the surrounding vehicle to perform the avoidance operation, such as a command “Please move the vehicle to the left and stop the vehicle”.

As illustrated in FIG. 10A, in the lane LN1, the vehicle 100a, the vehicle 100b, and the vehicle 100c are traveling in front of the emergency vehicle 200 (right side in the figure). It is assumed that the vehicle 100b and the vehicle 100c are traveling in the manual drive mode, and the vehicle 100a is traveling in the self-drive mode. In FIG. 10B, when the driver of each of the vehicle 100b and the vehicle 100c traveling in the manual drive mode recognizes the avoidance command by voice from the emergency vehicle 200, for example, the command “Please move the vehicle to the left and stop the vehicle”, the driver starts the driving operation according to the command. On the other hand, since the distance between the vehicle 100a and the emergency vehicle 200 is equal to or less than the first predetermined value (Pd1), the vehicle 100a traveling in the self-drive mode determines that the emergency vehicle 200 is approaching (S21). Since the movement corresponding to the avoidance command by the voice from the emergency vehicle 200 corresponds to the avoidance operation of the vehicle 100b and the vehicle 100c, the vehicle 100a performs the avoidance operation so as to follow the vehicle 100b and the vehicle 100c (S25, S29).

On the other hand, as illustrated in FIG. 10C, when there is a construction area CA in the opposite lane LN2, there is a possibility that the emergency vehicle 200 cannot pass between the vehicle 100a and the construction area CA even if the vehicle 100a stops on the left side of the road so as to follow the surrounding vehicle. In such a case, in order to cause the emergency vehicle 200 to travel in a roadside area of the lane LN1 (route RT in the figure), the emergency vehicle 200 may issue the avoidance command, such as “Please move the vehicle to the center of the road and stop the vehicle”, to the vehicle 100a. As described above, when the operation different from the avoidance operation of the surrounding vehicle is instructed from the nearby emergency vehicle 200, the vehicle 100a avoids the emergency vehicle 200 according to the avoidance command from the emergency vehicle 200 (S25, S26, S27, S28). However, when the state in which the movement of the surrounding vehicle and the movement corresponding to the avoidance command are different continues for a certain period of time, since it is assumed that the movement of the surrounding vehicle is more suitable avoidance operation, the vehicle 100a avoids the emergency vehicle 200 according to the movement of the surrounding vehicle (S25, S26, S27, S29).

According to the embodiment of the present invention, the following functions and effects can be obtained.

(1) The vehicle control apparatus 60 controls the vehicle 100 so that the vehicle travels according to a predetermined action plan. The vehicle control apparatus 60 includes the microphone 31b to which the voice emitted from the emergency vehicle 200 or the occupant of the emergency vehicle 200 to the surrounding vehicle is input, the voice recognition unit 412 that recognizes the notification information for the surrounding vehicle included in the voice input by the microphone 31b, and the avoidance action planning unit 415 (action plan generation unit 45) that controls the traveling operation of the vehicle 100 in response to the avoidance command when the voice recognition unit 412 recognizes that the avoidance command is included in the notification information. As a result, when the avoidance command by voice is issued from the emergency vehicle 200 or the occupant of the emergency vehicle 200, the vehicle 100 can suitably avoid the emergency vehicle 200 in response to the avoidance command.

(2) The vehicle control apparatus 60 further includes the positioning sensor 34 that detects the position of the vehicle 100, the data receiving unit 411 that acquires the position data of the emergency vehicle 200, and the determination unit 414 that determines whether or not the emergency vehicle 200 is approaching the vehicle 100 based on the position of the vehicle 100 detected by the positioning sensor 34 and the position data of the emergency vehicle 200 acquired by the data receiving unit 411. When the voice recognition unit 412 recognizes that the avoidance command is included in the notification information and the determination unit 414 determines that the emergency vehicle 200 is approaching the vehicle 100, the action plan generation unit 45 generates the action plan of the vehicle 100 in response to the avoidance command. There is a high possibility that the avoidance command from the emergency vehicle 200 separated from the vehicle 100 by a predetermined degree or more is not the avoidance command for the vehicle 100. Therefore, by following the avoidance command from the emergency vehicle 200 approaching the vehicle 100 as described above, the avoidance operation according to an unnecessary avoidance command can be suppressed.

(3) The vehicle control apparatus 60 further includes the surrounding circumstance detection unit 413 that detects the surrounding circumstance of the vehicle 100. When the voice recognition unit 412 recognizes that the avoidance command is included in the notification information, the action plan generation unit 45 generates the action plan of the vehicle 100 according to the surrounding circumstance detected by the surrounding circumstance detection unit 413 and the avoidance command. As a result, the avoidance operation is performed in consideration of not only the avoidance command by the voice from the emergency vehicle 200 but also the surrounding circumstance such as the movement of the surrounding vehicle, so that the emergency vehicle 200 can be more suitably avoided.

(4) The surrounding circumstance detection unit 413 detects the movement of the vehicle around the vehicle 100. When a state in which the movement of the surrounding vehicle detected by the surrounding circumstance detection unit 413 is different from the movement corresponding to the avoidance command included in the notification information continues for a predetermined time or more, the action plan generation unit 45 generates the action plan based on the movement of the surrounding vehicle detected by the surrounding circumstance detection unit 413.

For example, in a case where a traffic jam or a traffic accident occurs ahead of a preceding vehicle the vehicle 100, when the emergency vehicle 200 approaches from behind the vehicle 100, there is a possibility that the preceding vehicle cannot immediately respond to the avoidance command even if the avoidance command is issued from the emergency vehicle 200. This is because, in such a case, the preceding vehicle gives priority to the operation according to a road situation such as a traffic jam or a traffic accident over the operation according to the avoidance command from the emergency vehicle 200. Therefore, in such a case, as described above, the vehicle control apparatus 60 controls the traveling operation of the vehicle 100 so as to follow the movement of the preceding vehicle. As a result, the vehicle 100 can perform more suitable avoidance operation while considering the road condition such as a traffic jam or a traffic accident.

(5) The vehicle 100 is a vehicle having the self-driving capability of traveling by self-driving according to the action plan generated by the action plan generation unit 45. The vehicle control apparatus 60 further includes the memory unit 42 that stores the map data of the road, and the determination unit 414 that determines whether or not the vehicle 100 is within the predetermined range from the intersection based on the map data and the position of the vehicle 100 detected by the positioning sensor 34, and determines whether or not the emergency vehicle 200 enters the intersection based on the voice input by the microphone 31b. When the determination unit 414 determines that the vehicle 100 is within the predetermined range from the intersection and the determination unit 414 determines that the emergency vehicle 200 enters the intersection, the action plan generation unit 45 generates the action plan to stop the vehicle 100. At this time, when the voice recognition unit 412 recognizes that the notification information includes the information for notifying the entrance of the emergency vehicle 200 into the intersection, the determination unit 414 determines that the emergency vehicle 200 enters the intersection. As a result, it is possible to prevent the vehicle 100 from entering the intersection where the emergency vehicle 200 is entering, and the emergency vehicle 200 can smoothly pass through the intersection.

(6) The vehicle control apparatus 60 further includes the data receiving unit 411 that receives the command transmitted from the emergency vehicle 200, and the action plan generation unit 45 generates the action plan in response to the avoidance command included in the command from the emergency vehicle 200 received by the data receiving unit 411. As a result, the emergency vehicle 200 can be suitably avoided in response to the avoidance command by communication such as vehicle-to-vehicle communication.

In the above embodiment, although the microphone 31b inputs the voice emitted from the emergency vehicle 200 or the occupant of the emergency vehicle 200 to the surrounding vehicle, a configuration of an input unit is not limited to that described above. In the above embodiment, although the positioning sensor 34 detects the position of the vehicle 100, a configuration of a position detection unit is not limited to that described above. In the above embodiment, although the memory unit 42 stores the high-accuracy map data, the map database 35 as a map data memory unit may store the high-accuracy map data.

In the above embodiment, although the data receiving unit 411 acquires the position data of the emergency vehicle 200 from the emergency vehicle 200 via the communication unit 37, a configuration of a position data acquisition unit of the vehicle control apparatus is not limited to that described above. For example, the position data acquisition unit of the vehicle control apparatus may acquire the position data of the emergency vehicle 200 from the roadside apparatus of the vehicle-to-infrastructure communication system via the communication unit 37. In the above embodiment, although the data receiving unit 411 receives the command such as the avoidance command transmitted from the emergency vehicle 200, a configuration of a command receiving unit is not limited to that described above. For example, the command receiving unit may receive the command such as the avoidance command from the roadside apparatus of the vehicle-to-infrastructure communication system via the communication unit 37.

In the above embodiment, although the determination unit 414 determines whether or not the vehicle 100 is within the predetermined range from the intersection based on the map data and the position of the vehicle 100 detected by the positioning sensor 34, a configuration of a position determination unit is not limited to that described above. For example, the position determination unit may determine whether or not the vehicle 100 is within the predetermined range from the intersection based on data received from the roadside apparatus of the vehicle-to-infrastructure communication system. In the above embodiment, although the determination unit 414 determines whether or not the emergency vehicle 200 enters the intersection based on the voice input by the microphone 31b, a configuration of an entrance determination unit is not limited to that described above. For example, the entrance determination unit may determine whether or not the emergency vehicle 200 enters the intersection based on the siren (for example, change in frequency of a sound of the siren) of the emergency vehicle 200 input to the microphone 31b. Furthermore, for example, the entrance determination unit may determine whether or not the emergency vehicle 200 enters the intersection based on the data received from the roadside apparatus of the vehicle-to-infrastructure communication system.

In the above embodiment, the determination unit 414 determines whether or not the emergency vehicle 200 is approaching the vehicle 100 based on the position of the vehicle 100 and the position data of the emergency vehicle 200. However, a configuration of an approach determination unit of the vehicle control apparatus is not limited to that described above. For example, as illustrated in FIG. 10D, in a case where the emergency vehicle 200 traveling on the lane LN1 approaches the vehicle 100 traveling on the lane LN2, the vehicle 100 does not need to avoid the emergency vehicle 200 when a median strip MS is provided between the lane LN1 and the lane LN2. Therefore, the approach determination unit may determine whether or not there is a median strip between the lane on which the vehicle 100 travels and the lane on which the emergency vehicle 200 travels based on the position of the vehicle 100, the position data of the emergency vehicle 200, and the map data stored in the memory unit 42. When there is the median strip, the approach determination unit may determine that the emergency vehicle 200 does not approach the vehicle 100 regardless of the distance between the vehicle 100 and the emergency vehicle 200. The approach determination unit may determine not only the presence or absence of the median strip but also the presence or absence of a structure that blocks the movement of the vehicle between the lane on which the vehicle 100 travels and the lane on which the emergency vehicle 200 travels. When there is such a structure, the approach determination unit may determine that the emergency vehicle 200 does not approach the vehicle 100 regardless of the distance between the vehicle 100 and the emergency vehicle 200, more specifically, even when the distance between the vehicle 100 and the emergency vehicle 200 is equal to or less than the first predetermined value.

In addition, in the above embodiment, although the vehicle control apparatus 60 is applied to the vehicle control system of the self-driving vehicle, the vehicle control apparatus 60 is also applicable to vehicles other than the self-driving vehicle. For example, the vehicle control apparatus 60 can also be applied to the manually driven vehicle including the ADAS.

The above embodiment can be combined as desired with one or more of the above modifications. The modifications can also be combined with one another.

According to the present invention, it is possible to prevent for occupants of surrounding vehicles from knowing the position of the traveling emergency vehicle.

Above, while the present invention has been described with reference to the preferred embodiments thereof, it will be understood, by those skilled in the art, that various changes and modifications may be made thereto without departing from the scope of the appended claims.

What is claimed is:

1. A vehicle notification apparatus notifying an occupant of a vehicle of an approach of an emergency vehicle, the vehicle notification apparatus comprising:
a positioning sensor detecting a position of the vehicle; and
a microprocessor and a memory coupled to the microprocessor, wherein the microprocessor is configured to perform:
acquiring a position data of the emergency vehicle;
notifying an approach information of the emergency vehicle; and
determining whether the emergency vehicle is approaching the vehicle based on the position of the vehicle detected by the positioning sensor and the position data acquired in the acquiring, wherein
the microprocessor is configured to perform
the determining including further determining whether a notification of the approach information is permitted based on a command transmitted from the emergency vehicle; and
the notifying including, when it is determined that the emergency vehicle is approaching the vehicle and that the notification of the approach information is permitted, notifying the occupant of the approach information of the emergency vehicle, while when it is determined that the notification of the approach information is not permitted, not notifying the approach information even if it is determined that the emergency vehicle is approaching the vehicle.

2. The vehicle notification apparatus according to claim 1, wherein
the microprocessor is configured to perform:
the determining including determining a type of the emergency vehicle to determine whether the notification of the approach information is permitted based on the type of the emergency vehicle.

3. The vehicle notification apparatus according to claim 2, wherein
the microprocessor is configured to perform
the determining including determining that the notification of the approach information is not permitted when it is determined that the emergency vehicle is a predetermined emergency vehicle.

4. The vehicle notification apparatus according to claim 2, wherein
the microprocessor is configured to perform
the determining including determining a purpose of an emergency travel of the emergency vehicle to determine whether the notification of the approach information is permitted based on the type of the emergency vehicle and the purpose of the emergency travel.

5. The vehicle notification apparatus according to claim 1, wherein
the microprocessor is configured to perform:
the notifying including notifying of the approach information including an approach notification information for notifying an approach of the emergency vehicle and a position data of the emergency vehicle acquired in the acquiring;
the determining including determining, based on a command transmitted from the emergency vehicle, whether a notification of the approach notification information is permitted and whether a notification of the position data of the emergency vehicle is permitted; and
the notifying further including not notifying the position data of the emergency vehicle when it is determines that the notification of the position data of the emergency vehicle is not permitted.

6. The vehicle notification apparatus according to claim 1, wherein
the microprocessor is configured to perform:
the determining including determining a distance between the vehicle and the emergency vehicle based on the position of the vehicle detected by the positioning sensor and the position data acquired in the acquiring to determine that the emergency vehicle is approaching the vehicle when the distance between the vehicle and the emergency vehicle is equal to or less than a first predetermined value; and
the notifying including notifying, when the distance between the vehicle and the emergency vehicle is equal to or less than a second predetermined value smaller than the first predetermined value, the approach information of the emergency vehicle even when it is determines that the notification of the approach information is not permitted.

7. The vehicle notification apparatus according to claim 6, wherein
the second predetermined value is a distance that a traveling of the emergency vehicle is hindered unless the vehicle performs an avoidance operation immediately after determining that the emergency vehicle is approaching the vehicle.

8. The vehicle notification apparatus according to claim 1, wherein
the microprocessor is configured to further perform generating an action plan of the vehicle, and
the vehicle is a vehicle having a self-driving capability of traveling by self-driving according to the action plan generated in the generating, wherein
the microprocessor is configured to perform
the generating including generating the action plan of the vehicle so that the vehicle avoids the emergency vehicle when it is determined that the emergency vehicle is approaching while the vehicle is traveling by self-driving.

9. The vehicle notification apparatus according to claim 8, wherein
the microprocessor is configured to perform
the notifying including notifying, when the vehicle is traveling by self-driving, the approach information of the emergency vehicle even when it is determined the notification of the approach information is not permitted.

10. A vehicle notification system comprising:
the vehicle notification apparatus according to claim 1, and
a notification command apparatus including a microprocessor and a memory coupled to the microprocessor, wherein
the microprocessor is configured to perform transmitting a command to the vehicle notification apparatus, the command for causing the vehicle notification apparatus to execute a notification of an approach of an emergency vehicle.

11. A vehicle notification apparatus notifying an occupant of a vehicle of an approach of an emergency vehicle, the vehicle notification apparatus comprising:
a positioning sensor detecting a position of the vehicle; and
a microprocessor and a memory coupled to the microprocessor, wherein the microprocessor is configured to function as:
a position data acquisition unit configured to acquire a position data of the emergency vehicle;
an approach determination unit configured to determine whether the emergency vehicle is approaching the vehicle based on the position of the vehicle detected by the positioning sensor and the position data acquired by the position data acquisition unit;
a notification unit configured to notify an approach information of the emergency vehicle; and
a notification determination unit configured to determine a notification of the approach information is permitted based on a command transmitted from the emergency vehicle, wherein
the notification unit is configured to, when it is determined that the emergency vehicle is approaching the vehicle and that the notification of the approach information is permitted, notify the occupant of the approach information of the emergency vehicle, while not to, when it is determined that the notification of the approach information is not permitted, notify the approach information even if it is determined that the emergency vehicle is approaching the vehicle.

12. The vehicle notification apparatus according to claim 11, wherein
the microprocessor is configured to further function as:
a type determination unit configured to determine a type of the emergency vehicle, wherein,
the notification determination unit is configured to determine whether the notification of the approach information is permitted based on the type of the emergency vehicle.

13. The vehicle notification apparatus according to claim 12, wherein
the notification determination unit is configured to determine that the notification of the approach information is not permitted when it is determined that the emergency vehicle is a predetermined emergency vehicle.

14. The vehicle notification apparatus according to claim 12, wherein
the type determination unit is further configured to determine a purpose of an emergency travel of the emergency vehicle, and
the notification determination unit is configured to determine whether the notification of the approach information is permitted based on the type of the emergency vehicle and the purpose of the emergency travel.

15. The vehicle notification apparatus according to claim 11, wherein
the notification unit is configured to notify of the approach information including an approach notification information for notifying an approach of the emergency vehicle and a position data of the emergency vehicle acquired by the position data acquisition unit,
the notification determination unit is configured to determine, based on a command transmitted from the emergency vehicle, whether a notification of the approach notification information is permitted and whether a notification of the position data of the emergency vehicle is permitted, and
the notification unit is further configured not to notify the position data of the emergency vehicle when it is determines that the notification of the position data of the emergency vehicle is not permitted.

16. The vehicle notification apparatus according to claim 11, wherein
the approach determination unit is configured to determine a distance between the vehicle and the emergency vehicle based on the position of the vehicle detected by the positioning sensor and the position data acquired by the position data acquisition unit to determine that the emergency vehicle is approaching the vehicle when the distance between the vehicle and the emergency vehicle is equal to or less than a first predetermined value, and
the notification unit is further configured to notify, when the distance between the vehicle and the emergency vehicle is equal to or less than a second predetermined value smaller than the first predetermined value, the approach information of the emergency vehicle even when it is determines that the notification of the approach information is not permitted.

17. The vehicle notification apparatus according to claim 16, wherein
the second predetermined value is a distance that a traveling of the emergency vehicle is hindered unless the vehicle performs an avoidance operation immediately after determining that the emergency vehicle is approaching the vehicle.

18. The vehicle notification apparatus according to claim 11, wherein
the microprocessor is configured to further function as
an action plan generation unit configured to generate an action plan of the vehicle, wherein
the vehicle is a vehicle having a self-driving capability of traveling by self-driving according to the action plan generated by the action plan generation unit, and
the action plan generation unit is configured to generate the action plan of the vehicle so that the vehicle avoids the emergency vehicle when it is determined that the emergency vehicle is approaching while the vehicle is traveling by self-driving.

19. The vehicle notification apparatus according to claim 18, wherein
the notification unit is configured to notify, when the vehicle is traveling by self-driving, the approach information of the emergency vehicle even when it is determined the notification of the approach information is not permitted.

20. A vehicle notification system comprising:
the vehicle notification apparatus according to claim 11, and
a notification command apparatus including a microprocessor and a memory coupled to the microprocessor, wherein
the microprocessor is configured to function as
a notification command unit is configured to transmit a command to the vehicle notification apparatus, the command for causing the vehicle notification apparatus to execute a notification of an approach of an emergency vehicle.
